(19) United States
(12) Patent Application Publication
(10) Pub. No.: US 2012/0015859 A1
(43) Pub. Date: Jan. 19, 2012

(54) FLUID BLEACHING AGENT COMPOSITION

(75) Inventors: Fabian Sieben, Leverkusen (DE); Tatiana Schymitzek, Krefeld (DE)

(73) Assignee: Henkel AG & Co., KGaA, Dusseldorf (DE)

(21) Appl. No.: 13/245,029

(22) Filed: Sep. 26, 2011

Related U.S. Application Data
(63) Continuation of application No. PCT/EP2010/053085, filed on Mar. 11, 2010.

(30) Foreign Application Priority Data
Mar. 30, 2009 (DE) 10 2009 001 973.1

(51) Int. Cl. C11D 17/00; D06L 1/22

(52) U.S. Cl. 510/303; 8/137; 510/372

(57) ABSTRACT

The invention relates to an aqueous, fluid washing or cleaning agent comprising bleaching agent, comprising hydrogen peroxide and nonionic surfactant in the form of an alkoxylated alcohol and anionic surfactant, wherein the weight ratio of alkoxylated alcohol to anionic surfactant is in the range from 1:1 to 5:1, in particular 2:1 to 4:1, and the agent comprises a paraffin hydrocarbon.

### CROSS-REFERENCES TO RELATED APPLICATIONS

This application is a continuation of PCT/EP2010/053085, filed on Mar. 11, 2010, which claims priority under 35 U.S.C. §119 to DE 10 2009 001 973.1 filed on Mar. 30, 2009.

### FIELD OF THE INVENTION

The present invention generally relates to fluid bleaching agent compositions that can be used as agents for cleaning textile surfaces and hard surfaces.

### BACKGROUND OF THE INVENTION

Fluid bleaching agent compositions are known from the state of the art as washing agents, washing agent additives and also as wash pretreatment agents as well as cleaning agents for hard surfaces such as glazed or unglazed tiles or working surfaces in kitchens.

In wash pretreatment, such compositions which contain bleaching agents are used to improve the removal of encrusted dirt or spots or “problem spots,” such as grease, coffee, tea, grass or muddy, clayey soiling, which are difficult to remove by washing with the usual textile washing agents. Another area of use of such agents is for removal of local soiling from otherwise clean surfaces of textile sheeting, so that a more complex washing or cleaning process of the corresponding overall structure, whether a clothing item or a carpet or an upholstery part, can be avoided. With corresponding treatment with fluid agents which contain bleaching agent, acidic formulations are generally used when the bleaching agent is a peroxygen compound such as H₂O₂ because this remains stable in storage for a longer period of time under acidic conditions. However, hydrogen peroxide has a lower bleaching power under acidic conditions than under alkaline conditions. An effort is therefore usually made to work at a pH in the alkaline range in order to achieve the best possible bleaching results.

To improve the washing performance and/or spot removal performance of formulations that contain hydrogen peroxide, they may be combined with nonaqueous solvents. Such solvent-based preparations are especially suitable for direct spot pretreatment and also as washing agent additives and are especially effective against greasy and pigmented soiling. However, non-water-soluble solvents cannot normally be incorporated into water-based hydrogen peroxide preparations because phase separation occurs due to separation tendencies, in particular with prolonged storage.

Furthermore, other desirable features and characteristics of the present invention will become apparent from the subsequent brief summary and detailed description of the invention and the appended claims, taken in conjunction with this background of the invention.

### BRIEF SUMMARY OF THE INVENTION

The subject matter of the present invention relates to an aqueous fluid washing agent or cleaning agent which contains bleaching agent and contains hydrogen peroxide as well as nonionic surfactant in the form of an alkoxylated alcohol and anionic surfactant, where the weight ratio of alkoxylated alcohol to anionic surfactant is in the range of 1:1 to 10:1, in particular 2:1 to 4:1, and the agent contains a paraffinic hydrocarbon.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Preferably ethoxylated, propoxylated and/or butoxylated, advantageously ethoxylated, in particular primary alcohols, preferably with 8 to 18 carbon atoms and an average of 1 to 12 mol alkylene oxide per mol alcohol are used as the alkoxylated alcohols, in which the alcohol radical may be linear or branched, including in particular being methyl-branched in position 2 and/or may contain linear and branched radicals in mixture, such as those usually present in oxoalcohol radicals. Alcohol ethoxylates with linear radicals of alcohols of native origin with 12 to 18 carbon atoms from coconut, palm, tallow fatty or oleyl alcohol, for example, and with an average of 2 to 8 ethylene oxide (EO) per mol alcohol are preferred in particular. The preferred ethoxylated alcohols include, for example, C₁₂₋₁₄ alcohols with 3 EO, 4 EO or 7 EO, C₉₋₁₁ alcohols with 7 EO, C₁₃₋₁₅ alcohols with 3 EO, 5 EO, 7 EO or 8 EO, C₁₂₋₁₈ alcohols with 3 EO, 5 EO or 7 EO and mixtures thereof, such as mixtures of C₁₂₋₁₄ alcohol with 3 EO and C₁₂₋₁₈ alcohol with 7 EO. The degrees of ethoxylation indicated are statistical averages, which may be an integer or a fraction for a specific product. Preferred alcohol ethoxylates have a narrow homolog distribution (narrow range ethoxylates, NRE). Fatty alcohols with more than 12 EO may also be used. Examples of these include tallow fatty alcohol with 14 EO, 25 EO, 30 EO or 40 EO. Alkoxylated alcohols, which contain EO and PO groups together in the molecule, may also be used according to the invention. Block copolymer with EO-PO block units and/or PO-EO-PO block units may also be used here, but EO-PO-EO copolymers and/or PO-EO-PO copolymers may also be used. Mixed alkoxylated alcohols in which EO and PO units are not distributed by blocks but instead are distributed randomly may also be used. Such products can be obtained by simultaneous action of ethylene oxide and propylene oxide on fatty alcohols. Furthermore, mixtures of branch ethoxylated fatty alcohols and unbranched ethoxylated fatty alcohols are also suitable, for example, a mixture of a C₁₆₋₁₈ fatty alcohol with 7 EO and 2-propylheptanol with 7 EO.

Inventive agents preferably contain 3 wt % to 20 wt %, in particular 5 wt % to 12 wt % alkoxylated alcohol, where the weight percent information here and below is based on the total amount of washing agent or cleaning agent.

In addition to the alkoxylated alcohol, the inventive agent necessarily also contains an anionic surfactant. Sulfonates, sulfates, soaps and mixtures thereof are preferably used as the anionic surfactant.

The surfactants of the sulfonate type may preferably also include C₉₋₁₃ alkylbenzene sulfonates, olefin sulfonates, i.e., mixtures of alkene and hydroxyalkane sulfonates and disulfonates, such as those obtained from C₁₂₋₁₈ monoolefins with terminal or internal double bonds by sulfonation with gases sulfur trioxide and then alkaline or acidic hydrolysis of the sulfonation products, for example. Also suitable are alkane sulfonates obtained from C₁₂₋₁₈ alkanes, for example, by sulfochlorination or sulfoxidation with subsequent hydrolysis and/or neutralization. The esters of α-sulfo fatty acids (ester sulfonates), for example, the α-sulfonated methyl esters of hydrogenated coconut, palm kernel or tallow fatty acids, are likewise also suitable.

The alkali salts and in particular the sodium salts of sulfuric acid hemiesters of C₁₂₋₁₈ fatty alcohols, for example, from coconut fatty alcohol, tallow fatty alcohol, lauryl, myristyl, cetyl or stearyl alcohol or C₁₀₋₂₀ oxoalcohols and the hemiesters of secondary alcohols of these chain lengths are preferred as the alk(en)yl sulfates. Alk(en) yl sulfates of the aforementioned chain length, which contain a synthetic linear alkyl radical synthesized on a petrochemical basis and have a degradation behavior similar to that of adequate compounds based on raw materials known from fat chemistry, are also preferred. The C₁₂-C₁₆ alkyl sulfates and C₁₂-C₁₅ alkyl sulfates as well as C₁₄-C₁₅ alkyl sulfates are preferred from the standpoint of technical washing interest. 2,3-Alkyl sulfates, which are available as a commercial product of Shell Oil Co. and can be obtained under the brand name DAN®, are suitable anionic surfactants.

The sulfuric acid monoesters of linear or branched C₇₋₂₁ alcohols ethoxylated with 1 to 6 mol ethylene oxide, such as 2-methyl-branched C₉₋₁₁ alcohols with an average of 3.5 mol ethylene oxide (EO) or C₁₂₋₁₈ fatty alcohols with 1 to 4 EO are suitable and are used in preferred embodiments of the invention.

Other suitable anionic surfactants also include the salts of alkyl sulfosuccinic acid which are also known as sulfosuccinates or as sulfosuccinic acid esters and are the monoesters and/or diesters of sulfosuccinic acid with alcohols, preferably fatty alcohols and in particular ethoxylated fatty alcohols. Preferred sulfosuccinates contain C₈₋₁₈ fatty alcohol radicals or mixtures thereof. Preferred sulfosuccinates contain a fatty alcohol radical derived from ethoxylated fatty alcohols in particular, which are nonionic surfactants when considered alone. Sulfosuccinates whose fatty alcohols radicals are derived from ethoxylated fatty alcohols with a narrow homolog distribution are again especially preferred. It is likewise also possible to use alk(en)ylsuccinic acid with preferably 8 to 18 carbon atoms in the alk(en)yl chain or their salts.

Suitable anionic surfactants also include soaps, in particular saturated and unsaturated fatty acid soaps such as the salts of lauric acid, myristic acid, palmitic acid, stearic acid, (hydrogenated) erucaic acid and behenic acid as well as in particular soap mixtures derived from natural fatty acids, for example, coconut, palm kernel, olive oil or tallow fatty acids.

The anionic surfactants may be in the form of their sodium, potassium or magnesium salts. The anionic surfactants are preferably in the form of their sodium salts. Choline is another preferred counterion for anionic surfactants.

The anionic surfactant content of an inventive agent is preferably 1 wt % to 15 wt %, in particular 1.5 wt % to 7 wt %.

The paraffinic hydrocarbons contained in the inventive agent are liquid at room temperature. Normally they are mixtures of hydrocarbon chains of various lengths, which may be linear or branched. They normally do not contain any hydrocarbons with more than 17 carbon atoms. The inventive agents preferably contain branched-chain isoparaffins, where C₁₂₋₁₄ isoparaffins are especially preferred. An inventive agent preferably contains 0.1 wt % to 2.5 wt %, in particular 0.5 wt % to 1.5 wt % paraffinic hydrocarbon.

The hydrogen peroxide content in the inventive agent is preferably 0.5 wt % to 5 wt %, in particular 1 wt % to 3 wt %.

It is possible that an inventive agent consists of water in addition to the aforementioned surfactant ingredients, the paraffin and hydrogen peroxide. Optionally, however, other conventional ingredients of washing agents or cleaning agents, in particular additional surfactants, chelating agents, hydrotropic agents, radical scavengers, foam inhibitors, foam enhancers, soil release agents, dyes and/or scents but also dye transfer inhibitors and/or so-called fiber care ingredients may also be present.

Other suitable surfactants are those of the alkylamine oxide type having an alkyl group which corresponds to those in the aforementioned alkoxylated alcohols and two shorter alkyl groups such as methyl, ethyl or propyl groups. Of the alkylamine oxides, C₈₋₂₂ alkyldimethylamine oxides, in particular C₁₂₋₁₄ alkyldimethylamine oxides are preferred. Amine oxide is preferably present in the inventive agent in amounts up to 2 wt %, in particular 0.2 wt % to 1 wt %.

The other suitable surfactants also include N-alkylpyrrolidones, whose alkyl group preferably has 6 to 22 carbon atoms, in particular 8 to 12 carbon atoms, which may be branched-chain or preferably linear. N-Alkylpyrrolidone is preferably present in the inventive agent in amounts of up to 2 wt %, in particular 0.5 wt % to 1.5 wt %.

Hydrotropic agents, which may be used in the inventive agents, preferably originate from the group of monovalent or polyvalent alcohols, alkanolamines, ketones, ethers, esters or glycol ethers, which are miscible with water at room temperature at least partially, especially preferably to an unlimited extent. The hydrotropic agents are preferably selected from ethanol, n propanol or isopropanol, the butanols, ethylene glycol, propylene glycol and butylene glycol, acetone, acetic acid methyl ester, acetic acid ethyl ester, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl ether or ethyl ether, diisopropylene glycol monomethyl ether or ethyl ether, methoxy-, ethoxy- or butoxytriglycol, 1-butoxyethoxy-2-propanol, 3 methyl-3-methoxybutanol, propylene glycol t-butyl ether as well as mixtures of these. Hydrotropic agents may optionally be used in the inventive agents in amounts of up to 1 wt %, preferably up to 0.8 wt % and in particular from 0.1 wt % to 0.5 wt %.

For setting the viscosity, one or more thickeners and/or thickening systems may be added to the inventive composition. The viscosity of the inventive compositions can be measured using conventional standard methods (for example, Brookfield viscometer RVD-VII at 20 rpm and 20° C., spindle 3) and is preferably in the range of 200 mPas to 120 mPas, in particular 400 mPas to 900 mPas. Suitable thickeners are usually polymeric compounds, which are also known as swelling agents, usually of organic high molecular substances which absorb fluids, then swell and ultimately develop into true viscous solutions or colloidal solutions, originate from the groups of the natural polymers, modified natural polymers and fully synthetic polymers. Natural polymers which are used as thickeners include, for example, agar, carrageenan, gum tragacanth, gum arabic, alginates, pectins, polyoses, gellan, diutan, guar meal, carob bean gum, starch, dextrins, gelatin and casein. Modified natural substances originate mainly from the group of modified starches and celluloses; for example, carboxymethyl cellulose may be mentioned here. Methylcellulose and other cellulose ethers, hydroxy [symbol] ethyl [symbol] cellulose and propylcellulose as well as kernel meal ether may be mentioned. A large group of thickeners which are widely used in a wide variety of area of application include the fully synthetic polymers such as polyacrylic compounds and polymethacrylic compounds, vinyl polymers, vinyl carboxylic acids, polyethers, polyimines, polyamides and polyurethanes. However, so-called swelling clays, for example, sodium and magnesium silicates are also suitable.

To increase the stability in storage, chelating agents may additionally be used in the inventive agents. Examples of chelating agents include low-molecular hydroxycarboxylic acids such as citric acid, tartaric acid, malic acid or gluconic acid and/or their salts, but citric acid or sodium citrate is especially preferred. To avoid the heavy metal-catalyzed decomposition of certain wash [symbol] ing agent ingredients, in particular hydrogen peroxide, substances which chelate the heavy metals may be added. Suitable heavy metal chelating agents include, for example, ethylenediamine tetraacetic acid (EDTA), nitrilotriacetic acid (NTA) or N,N-biscarboxymethylalanine in the form of their free acids or as alkali metal salts and derivatives thereof as well as the alkali salts of anionic polyelectrolytes such as polymaleates and polysulfonates. Phosphonates are a preferred class of chelating agents. These preferred compounds include in particular organophosphonates, for example, 1-hydroxyethane-1,1-diphos [symbol] phonic acid (HEDP), aminotri(methylene phosphonic acid) (ATMP), diethylene triaminepenta(methylene phosphonic acid) (DTPMP and/or DETPMP) as well as 2-phosphonobutane-1,2,4-tricarboxylic acid (PBS-AM) most of which are used in the form of their ammonium salts or alkali metal salts. Chelating agents are preferably present in the inventive agents in amounts of 0.01 wt % to 2.0 wt %, in particular from 0.05 to 0.5 wt %.

Suitable soil release active ingredients include, for example, the polymers of phthalic acid and/or terephthalic acid and/or their derivatives, which are known from the state of the art, in particular polymers of ethylene terephthalates and/or polyethylene glycol terephthalates or anionically and/or nonionically modified derivatives of these. Polyacrylates may optionally also be used.

The active ingredients which are known as radical scavengers and are preferably present in the inventive agents in amounts of 0.01 wt % to 0.1 wt % include phenols such as 1,6-di-tert-butyl-4-methylphenol (butyl hydroxytoluene, BHT), hydroquinones such as di-tert-butylhydroquinone, catechols such as allyl catechol, alkylated diphenylamines or N-phenyl-α-naphthylamines and dihydroquinolines. BHT is a preferred radical scavenger. To be able to rapidly incorporate such normally sparingly water-soluble substances into the inventive agents, it has proven suitable to incorporate them in the form of a solution in a water-miscible solvent, for example, a low alcohol such as ethanol or isopropanol.

Optical brighteners may optionally be added to the inventive compositions to eliminate graying and yellowing of the treated textiles. These substances are absorbed onto the fiber and cause brightening and a simulated bleaching effect by converting invisible ultraviolet radiation into visible light of a longer wavelength, such that the ultraviolet light absorbed from the sunlight is emitted as a weakly bluish fluorescence and yields pure white when combined with the yellow hue of the grayed and/or yellowed laundry. Suitable compounds originate, for example, from the substance classes of the 4,4′-diamino-2,2′-stilbenedisulfonic acids (flavonic acids), 4,4′-distyrylbiphenylene, methyl umbelliferones, coumarins, dihydroquinolinones, 1,3-diarylpyrazoline, naph [symbol] thalic acid imide, benzoxazole, benzisoxazole and benzimidazole systems as well as the heterocycle-substituted pyrene derivatives. Optical brighteners are usually added in amounts between 0.01 and 0.3 wt %, based on the finished composition, but may also be omitted entirely, in particular when the agents are to be used for cleaning sensitive and/or colored surfaces.

The agents may contain dye transfer inhibitors, which in a preferred embodiment comprise a polymer of vinyl [symbol] pyrrolidone, vinyl [symbol] imidazole, vinyl [symbol] pyridine N-oxide or a copolymer thereof. Of the copolymers, those of vinyl [symbol] pyrrolidone and vinylimidazole in a molar ratio of 5:1 to 1:1 with an average molecular weight in the range of 5000 to 50,000, in particular 10,000 to 20,000 are preferred.

The textile sheeting of rayon, cellulose, cotton and blends thereof in particular may tend to wrinkle because the individual fibers are sensitive to bending, kinking, pressing and squeezing across the direction of the fiber, so the inventive compositions may contain synthetic antiwrinkle agents. These include, for example, synthetic products based on fatty acids, fatty acid esters, fatty acid amides, alkylol esters, alkylolamides or fatty alcohols, most of which are reacted with ethylene oxide, or products based on lecithin or modified phosphoric acid esters.

The inventive compositions are synthesized continuously or in a batch process by simply mixing the ingredients, preferably using water, solvents and surfactant(s) at first and adding the other ingredients by portions. Separate heating during preparation is not necessary if it is desired that the temperature of the mixture not exceed 80° C. The inventive agents may be bottled in the usual bottles, optionally in those with gas-permeable closure systems from which they can be poured or optionally sprayed through nozzle openings onto the surface to be cleaned.

An inventive agent preferably has a pH in the range of pH 4 to pH 6, in particular in the range of pH 5 to pH 5.5. By adding conventional acids which are compatible with the system, in particular citric acid, lactic acid or malic aid, pH levels in these ranges can easily be adjusted if they are not obtained already by combining the other ingredients.

The inventive agents are preferably used for cleaning soiled surfaces of textile sheeting, which may be washable, in particular a clothing item or non-washable household textiles, in particular a textile upholstery material or a carpet or they may be used as a wash additive or for cleaning soiled hard surfaces. However, they may also be used as an all purpose washing agent or as a detergency enhancer. Their use as a household cleaning agent in wet rooms, for example, and in the kitchen as a dishwashing washing agent or for cleaning upholstery or carpets is also possible.

For cleaning soiled surface of textile sheeting, it is preferable to proceed by first applying the inventive agent to the textile or at least to the soiled parts of the textile, allowing it to act there and then removing it by treatment with water. This treatment step with water maybe performed as part of a conventional manual or machine textile washing method, so that then the inventive treatment corresponds to a conventional pretreatment step.

For treatment of the textile surface, an inventive agent is usually applied to the textile sheeting over a period of up to 24 hours, in particular from 30 seconds up to an hour and especially preferably from 1 minute to 30 minutes. For treating hard surfaces, the same thing is true, but periods of time at the lower end of the stated ranges may be considered here in particular. The period of time should be selected so that the fluid composition does not dry on the surface. The surfaces to be cleaned are usually soiled with dried-on spots or dirt, which are usually very difficult to remove. The liquid agents may be applied easily to the surface and left there and then rinsed off, but the soil removal may also be supported by mechanical support, for example, by rubbing or by treating with a sponge or a brush. Likewise the removal may be accomplished by treating with water with the help of a moistened sponge or cloth. The latter is recommended not only for hard surfaces but in particular also for sensitive non-washable home textiles, such as textile upholstery materials or carpets.

The inventive agents are usually applied in undiluted form to the textiles and/or the substrate to be treated. However, they may optionally also be treated with water before use. They may also be used as additive in a conventional washing method, in particular in a machine washing method together with a conventional washing agent.

### EXAMPLES

Washing agents of the following overall composition (amount in wt %) were prepared:

| | E1 | E2 |
|---|---|---|
| C₁₂₋₁₄ Fatty alcohol with 7 EO | 6 | 10 |
| C₁₂₋₁₆ Fatty alcohol with 2 EO sulfate, Na salt | 1.5 | 1.5 |
| N-Laurylpyrrolidone | 1 | − |
| C₁₂₋₁₄ Alkyldimethylamine oxide | − | 0.6 |
| Hydrogen peroxide | 6.5 | 4.5 |
| C₁₂₋₁₄ Isoparaffin | 1 | 1 |
| Xanthan | 0.4 | 0.1 |
| Etidronic acid | 0.05 | 0.05 |
| N,N-Biscarboxymethylalanine, sodium salt | 0.1 | 0.1 |
| Ethanol | 0.1 | 0.1 |
| BHT | 0.03 | 0.03 |
| Soil release polyester | 0.5 | − |
| Dye | + | − |
| Perfume | + | + |
| Water | To 100 | To 100 |

Both compositions have a pH of approximately 5 to 5.5. E1 had a viscosity of approximately 850 mPas, while E2 had approximately 450 mPas.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. An aqueous fluid washing or cleaning agent containing bleaching agent, which contains hydrogen peroxide as well as nonionic surfactant in the form of an alkoxylated alcohol and anionic surfactant, wherein the weight ratio of alkoxylated alcohol to anionic surfactant is in the range of 1:1 to 10:1, and the agent contains a paraffinic hydrocarbon.

2. The agent according to claim 1, wherein it contains 3 wt % to 20 wt % alkoxylated alcohol.

3. The agent according to claim 1, wherein the alkoxylated alcohol is selected from ethoxylated, propoxylated and/or butoxylated alcohols with 8 to 12 carbon atoms and an average of 1 to 12 mol alkylene oxide per mol alcohol.

4. The agent according to claim 1, wherein it contains 1 wt % to 15 wt % anionic surfactant.

5. The agent according to claim 4, wherein the anionic surfactant is a sulfuric acid monoester of linear or branched C₇₋₂₁ alcohols ethoxylated with 1 to 6 mol ethylene oxide.

6. The agent according to claim 1, wherein it contains 0.1 wt % to 2.5 wt % paraffinic hydrocarbon.

7. The agent according to claim 1, wherein it contains 0.5 wt % to 5 wt % hydrogen peroxide.

8. The agent according to claim 1, wherein it further comprises ingredients selected from the group consisting of additional surfactants, chelating agents, hydrotropic agents, radical scavengers, foam inhibitors, foam enhancers, soil release active ingredients, dyes, scents, dye transfer inhibitors and so-called fiber care active ingredients.

9. Use of a composition according to claim 1 for cleaning soiled textile surfaces.

10. The use according to claim 9, wherein the composition is applied to the soiled parts of the textile, allowed to act there and then is removed by treatment with water.

11. The use according to claim 10, wherein the textile is selected from the group consisting of clothing items, upholstery materials and carpets.

12. The use of a composition according to claim 1 for cleaning soiled hard surfaces.
